(19) United States
(12) Patent Application Publication
(10) Pub. No.: US 2021/0117630 A1
(43) Pub. Date: Apr. 22, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Tomoyuki ITO, Kanagawa (JP); Masato ANDO, Kanagawa (JP); Hirokazu MUKAI, Kanagawa (JP); Minoru KASAMA, Kanagawa (JP)

(73) Assignee: FUJI XEROX CO., LTD., Tokyo (JP)

(21) Appl. No.: 16/892,298

(22) Filed: Jun. 4, 2020

(30) Foreign Application Priority Data
Oct. 21, 2019 (JP) 2019-192044

(51) Int. Cl. G06F 40/40

(52) U.S. Cl. CPC G06F 40/40

(57) ABSTRACT

An information processing apparatus includes a conversion section that converts, on an relation diagram expressing a logical relationship between a plurality of events, the logical relationship of a designated location into a natural language and outputs the natural language.

### CROSS-REFERENCE TO RELATED APPLICATIONS

This application is based on and claims priority under 35 USC 119 from Japanese Patent Application No. 2019-192044 filed Oct. 21, 2019.

### BACKGROUND

### (i) Technical Field

The present invention relates to an information processing apparatus and a non-transitory computer readable medium storing a program.

### (ii) Related Art

In recent years, an information processing apparatus which facilitates creation of a table related to quality function development is proposed (for example, see JP2016-081185A).

An information processing apparatus described in JP2016-081185A connects, in a quality function development process, function items having a dependency relationship according to the dependency relationship, creates an relation diagram with attribute information for specifying the process to which the function item belongs for each function item belonging to any one of processes on a system diagram in which a plurality of function items are organized, extracts each function item, the attribute information of the function item, and dependency information of the function item from the relation diagram in a case where the relation diagram is input and stores the attribute information and the dependency information as original information, and sets an axis of a deployment table or a multi-way table to create and output the deployment table or the multi-way table corresponding to the set axis by using the original information.

### SUMMARY

In creating an relation diagram expressing a logical relationship between a plurality of events, it is difficult to examine accuracy of the logical relationship between the events or a plurality of factors for the event by using only the relation diagram.

Aspects of non-limiting embodiments of the present disclosure relate to an information processing apparatus and a non-transitory computer readable medium storing a program that assist, in creating an relation diagram expressing a logical relationship between a plurality of events, examining accuracy of the logical relationship between the events or a plurality of factors for the event.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a conversion section that converts, on an relation diagram expressing a logical relationship between a plurality of events, the logical relationship of a designated location into a natural language and outputs the natural language.

### BRIEF DESCRIPTION OF THE DRAWINGS

Exemplary embodiment(s) of the present invention will be described in detail based on the following figures, wherein:

FIG. 1 is a block diagram illustrating a schematic configuration example of an information processing apparatus according to an exemplary embodiment of the invention;

FIG. 2 is a diagram illustrating an example of an relation diagram;

FIG. 3 is a diagram illustrating an example of an attribute table;

FIG. 4 is a diagram illustrating an example of a conversion table;

FIGS. 5A and 5B schematically illustrate a schematic configuration example of a model for which an relation diagram is to be created, and FIG. 5A is a plan view and FIG. 5B is a side view;

FIGS. 6A to 6C are diagrams illustrating an example of an relation diagram;

FIGS. 7A and 7B are diagrams illustrating an example of another relation diagram;

FIGS. 8A and 8B are diagrams illustrating an example of still another relation diagram;

FIGS. 9A and 9B are diagrams illustrating an example of still another relation diagram;

FIG. 10 is a diagram illustrating an example of a conversion table according to Modification 1;

FIG. 11 is a diagram illustrating an example of still another relation diagram;

FIG. 12 is a diagram illustrating an example of an relation diagram according to Modification 2;

FIG. 13 is a diagram illustrating an example of a conversion table according to a second exemplary embodiment of the invention;

FIGS. 14A and 14B are diagrams illustrating an example of still another relation diagram;

FIG. 15 is a diagram illustrating an example of an relation diagram according to a third exemplary embodiment of the invention;

FIG. 16 is a diagram illustrating an example of a conversion table according to the third exemplary embodiment;

FIG. 17A is a diagram illustrating an example of still another relation diagram;

FIG. 17B is a diagram illustrating an example of still another relation diagram;

FIG. 17C is a diagram illustrating an example of still another relation diagram;

FIG. 17D is a diagram illustrating an example of still another relation diagram;

FIG. 18A is a diagram illustrating an example of still another relation diagram;

FIG. 18B is a diagram illustrating an example of still another relation diagram;

FIG. 18C is a diagram illustrating an example of still another relation diagram;

FIG. 19 is a diagram illustrating an example of still another relation diagram;

FIG. 20 is a diagram illustrating an example of still another relation diagram; and

FIG. 21 is a diagram illustrating an example of still another relation diagram.

### DETAILED DESCRIPTION

Hereinafter, exemplary embodiments according to the present disclosure will be described with reference to drawings. In each drawing, components having substantially the identical function are denoted by the same reference numerals, and redundant description is not repeated.

### SUMMARY OF EXEMPLARY EMBODIMENT

An information processing apparatus according to the present exemplary embodiment includes a conversion section that converts, on an relation diagram expressing a logical relationship between a plurality of events, the logical relationship of a designated location into a natural language and outputs the natural language.

A logical relationship includes a causal relationship, an equal relationship, an opposition relationship, and the like. The causal relationship refers to a relationship in which a change in a physical quantity defined in one event causes a corresponding change in a physical quantity defined in the other event such as a cause or a factor and a result, a reason and an assertion between events. An relation diagram is a diagram illustrating a logical relationship between a plurality of events.

### EXEMPLARY EMBODIMENT

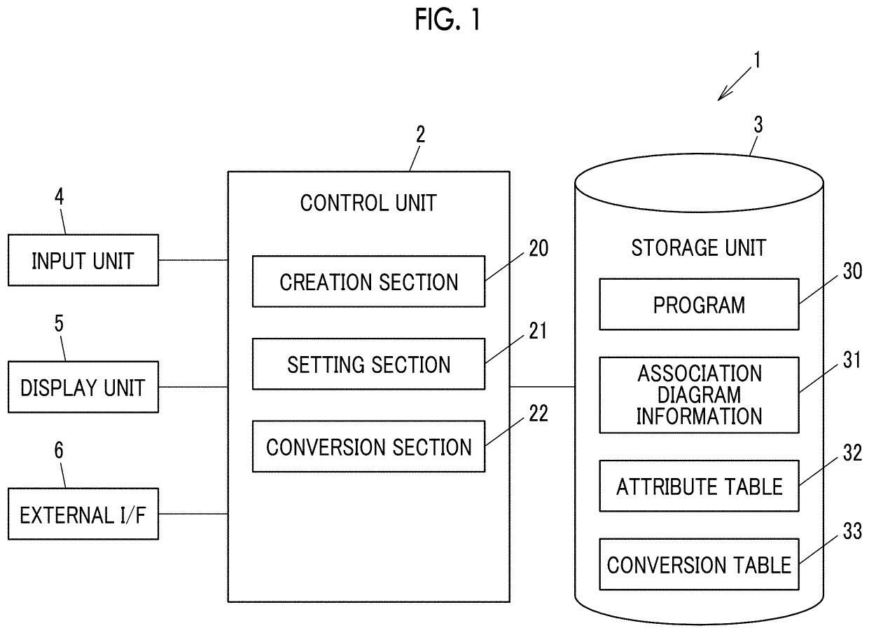

FIG. 1 is a block diagram illustrating a schematic configuration example of an information processing apparatus according to an exemplary embodiment of the invention. An information processing apparatus 1 includes a control unit 2, a storage unit 3, an input unit 4, a display unit 5, and an external interface (I/F) 6.

The control unit 2 is configured to include a central processing unit (CPU), an interface, and the like. The CPU functions as a creation section 20, a setting section 21, a conversion section 22, or the like by executing a program 30 stored in the storage unit 3. Details of each of the sections 20 to 22 will be described below.

The storage unit 3 is configured to include a read only memory (ROM), a random access memory (RAM), a hard disk, and the like, and stores various types of information such as the program 30, relation diagram information 31, an attribute table 32, and a conversion table 33.

The relation diagram information 31 has, for example, image data and additional data. The image data includes objects such as boxes, connectors, and the like constituting the relation diagram. The additional data refers to data generated on the information processing apparatus 1 side in association with generation of an relation diagram created by an operation of the input unit 4 by a user, and includes, for example, position information of the object in the relation diagram, a box ID for identifying a box, and the like. The box is represented by, for example, a rectangular frame, and a name of an event or the like is input inside. The connector is a line connecting the boxes by a straight line or a curve, for example, and has an arrow at a tip on the connection destination side. The connector may not have the arrow at the tip. The box is an example of an event component. The connector is an example of a connection component.

The input unit 4 is realized by, for example, a keyboard, a mouse, and the like. The display unit 5 is realized by, for example, a liquid crystal display or the like. The external I/F 6 is realized by a network interface card (NIC) or the like, and transmits and receives information to and from an external apparatus such as an external database via a network.

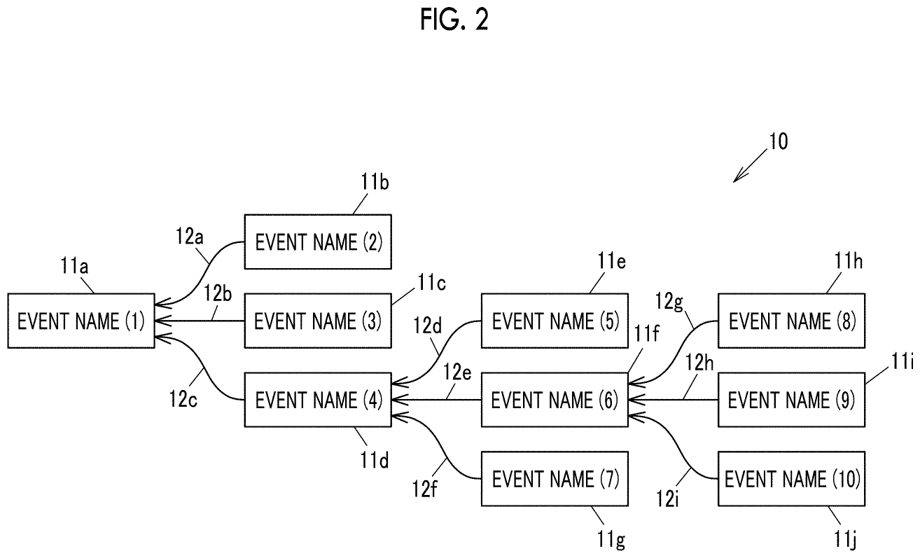

FIG. 2 is a diagram illustrating an example of an relation diagram. An relation diagram 10 expresses, for example, a plurality of events in a logical relationship. In the present exemplary embodiment, a causal relationship is illustrated as the logical relationship. The causal relationship includes a cause or a factor and a result, a reason and an assertion, and the like, and in this exemplary embodiment, a causal relationship between the cause or the factor and the result will be described.

As illustrated in FIG. 2, the relation diagram 10 is configured to include a plurality of boxes 11a, 11b, 11c, . . . (hereinafter, collectively referred to as “box 11”) indicating an event displayed by surrounding an event name such as an event name (1), an event name (2), or the like with a rectangular frame and connectors 12a, 12b, 12c, . . . which connect the boxes with lines (hereinafter, collectively referred to as “connector 12”).

Each of the displayed boxes 11 has a plurality of hierarchical structures such as, for example, quality, a function, a physical characteristic value, and a design parameter. The box 11 on the left side in FIG. 2 is also called a parent event (for example, a result), and the box 11 on the right side is also called a child event (for example, a cause or a factor).

In FIG. 2, the connectors 12 indicating the relationship between the boxes 11 are all displayed by the same type of line, but a thickness of the line or the type of the line may be changed in accordance with the relationship between the boxes 11, that is, a strength of the relationship.

When the relation diagram 10 is created, ambiguities and assumptions are likely to be input. For example, it is assumed that two factors of “building” as a factor such as aging of the building and “dry” as low humidity of the year are considered as factors of “fire is increasing”. In fact, there may be another factor such as “arson”. In addition, considering that “fire increases as drying makes building materials more flammable”, these two factors are not independent. Meanwhile, when actually executing an operation developed on an relation diagram, when listening to description for a causal relationship at a meeting, or the like, in a case where a reasonable candidate appears, the thought stops, and the factor proceeds as it is, in many cases. This can lead to a completely different relation diagram depending on a person, or is a major cause of unreasonable development. As a solution, there is a system of checking that a causal relationship is appropriate by always writing magnitude or an increase/decrease such as “large” or “decrease”, but the system is not sufficient.

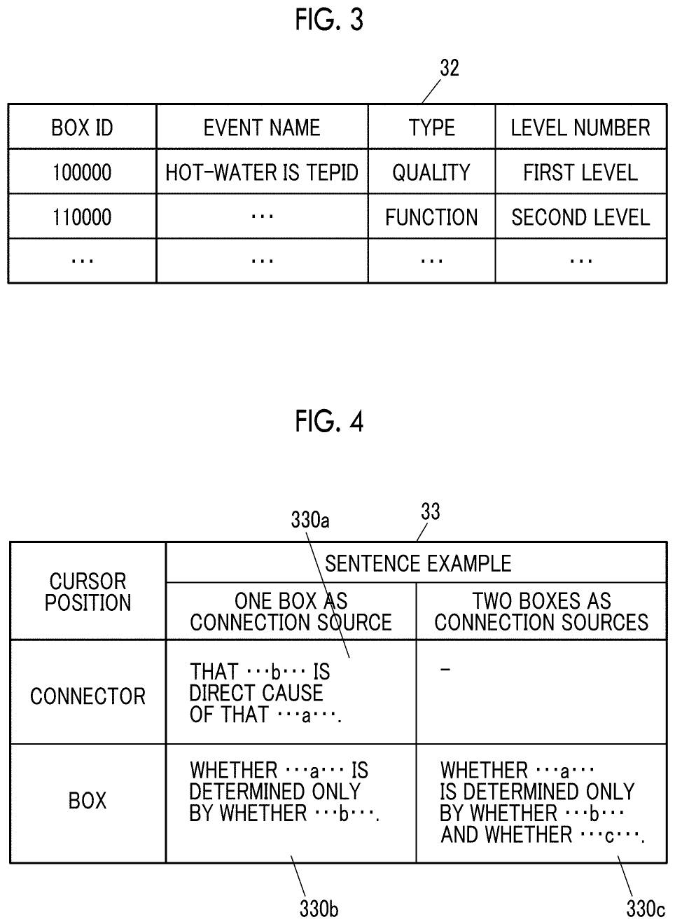

FIG. 3 is a diagram illustrating an example of the attribute table 32. The attribute table 32 has items such as “box ID”, “event name”, “type”, and “level number”. In the “box ID”, a box ID for identifying a box is recorded. In the “event name”, a name of an event is recorded. In the “type”, for example, quality, a function, a physical characteristic value, a design parameter, and the like are recorded as a type of the event. In the “level number”, a level number is recorded from left to right, such as a first level and a second level.

There are a case where the boxes 11 are connected by the connector 12, a case where the boxes 11 are connected from one downstream box 11 (hereinafter, also referred to as a connection source) to one upstream box 11 (hereinafter, also referred to as a connection destination), a case where a plurality of boxes 11 as connection sources are connected to one box 11 as a connection destination, and a case where one box 11 as a connection source is connected to a plurality of boxes 11 as connection destinations. In some cases, the box 11 at the lower level by one is connected to the box 11 in the upper level, or the box 11 at the two or more lower level is connected to the box 11 in the upper level.

FIG. 4 is a diagram illustrating an example of the conversion table 33. The conversion table 33 has items such as “cursor position” and “sentence example”. The “cursor position” includes a connector and a box. The sentence example includes a case where the number of connection source boxes is one and a case where the number of connection source boxes is two. In the case where the number of connection source boxes is one, sentences are completed by inserting an event name of a connection source in b of sentence examples 330a and 330b and inserting an event name of a connection destination in a of sentence examples 330a and 330b. In the case where there are two connection source boxes, a sentence is completed by inserting an event name of a connection destination in a of a sentence example 330c, inserting an event name of one connection source in b of the sentence example 330c, and inserting an event name of the other connection source in c of the sentence example 330c. The sentence is an example of a natural language.

Next, each of the sections 20 to 22 of the control unit 2 will be described.

The creation section 20 creates the relation diagram 10 from information input by the input unit 4 being operated, and stores the relation diagram 10 in the storage unit 3 as the relation diagram information 31. Further, the creation section 20 generates the relation diagram 10 based on the relation diagram information 31 and displays the relation diagram 10 on the display unit 5.

The setting section 21 sets attribute information to the box 11 and the connector 12 constituting the relation diagram 10 based on the information input by the input unit 4 being operated. The attribute information is recorded in the attribute table 32. The attribute information is not limited to the event name, the type, and the level number, and may include a creation date and time, an update date and time, a creator, a strength of a causal relationship, and the like.

The conversion section 22 converts a logical relationship of a designated location into a sentence with respect to the relation diagram 10 and outputs the sentence.

The conversion section 22 outputs the sentence according to whether the designated location is the box 11 or the connector 12. That is, in a case where the designated location is the box 11, the conversion section 22 outputs a sentence for checking whether or not an event directly connected as a factor of the event is appropriate as the factor, for example, a sentence for checking that there is no event other than an event directly connected as a factor of the event (for example, not limited to the expression in FIG. 4, any omissions?, is that all?, no more?, and the like), a sentence for checking whether or not there is a word which expresses a factor (for example, an expression of “something becomes something” instead of a name of an object), a sentence for checking whether or not there is a repetition (for example, in a case where “dry” and “building materials are flammable” are considered as factors of “fire is easy to occur”), and the like. In a case where the designated location is the connector 12, the conversion section 22 outputs a sentence for checking whether or not an event connected as a factor of the event is appropriate as the factor, for example, a sentence for checking that an event connected as a factor of the event is a direct factor, and the like.

Further, the conversion section 22 may display a plurality of candidate sentences in a selectable pop-up manner. In this case, the plurality of sentence examples are prepared corresponding to each cell although one of the sentence examples 330a to 330c corresponding to each cell is prepared in the conversion table 33 in FIG. 4.

Operation of Information Processing Apparatus

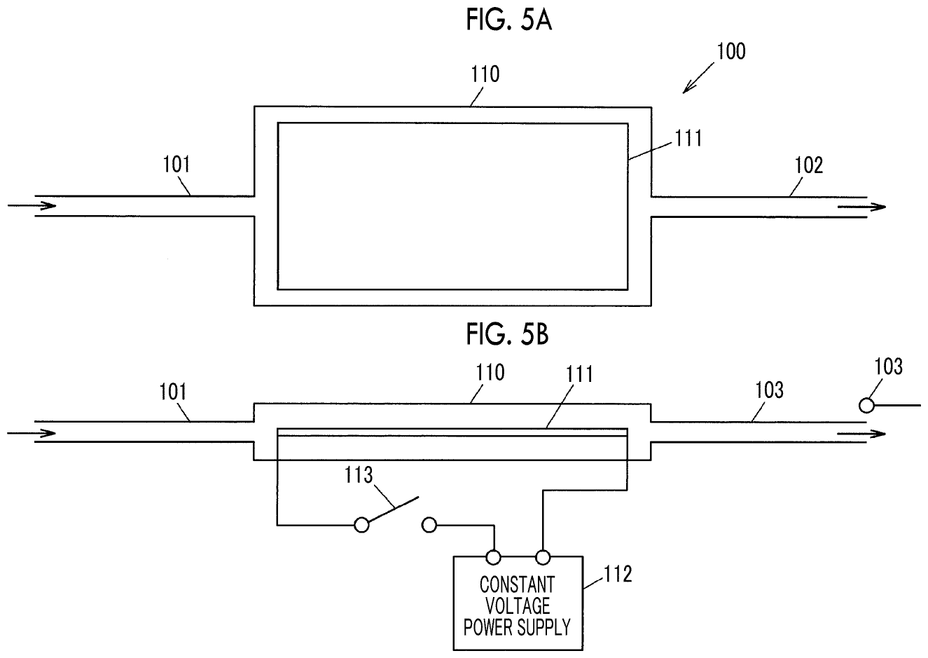

Next, an example of an operation of the information processing apparatus 1 will be described with reference to FIGS. 5 to 9.

FIGS. 5A and 5B schematically illustrate a schematic configuration example of a model for which an relation diagram is to be created. A model 100 is a simple water heater, and has an inflow pipe 101 into which water flows from a water pipe, a heating unit 110 which heats the water flowing through the inflow pipe 101, an outflow pipe 102 through which the water heated by the heating unit 110 flows, and a water stop valve 103 which stops the outflow from the outflow pipe 102.

The heating unit 110 includes a plate-type heater 111, a constant voltage power supply 112 which applies a voltage to the heater 111, and a switch 113 which stops the application of the voltage to the heater 111.

It is assumed that the creator instructs to list factors (including design items and disturbances) to be held down to ensure quality of “hot water temperature is high” of the simple water heater illustrated in FIG. 5 so that there is no omission or repetition.

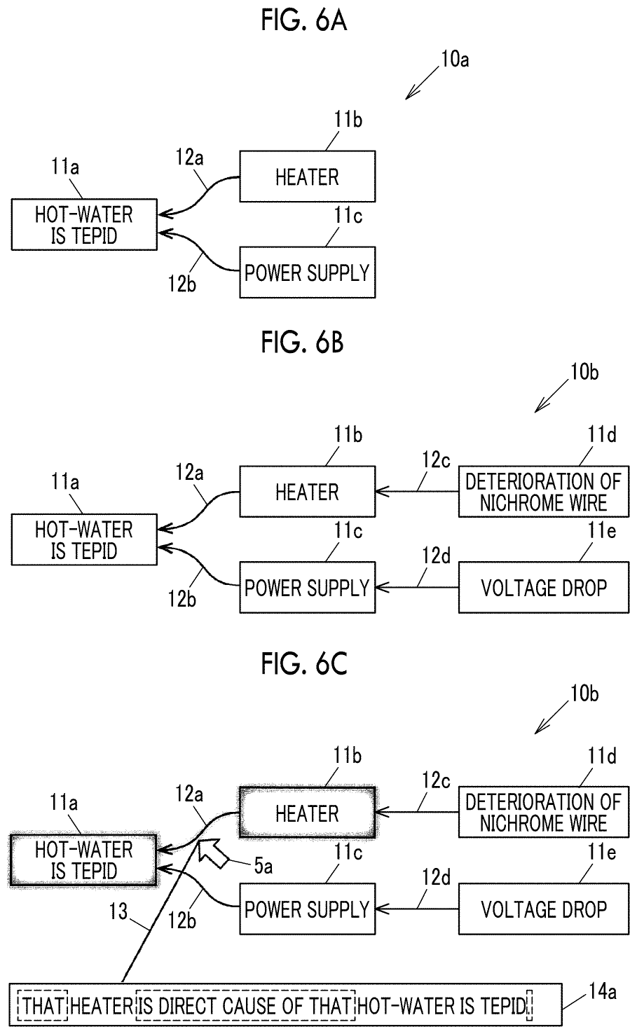

It is assumed that the creator thinks that “in a case where heating cannot be neatly performed, there is a problem with a heater or a problem with a power supply system”, and starts drawing a tree as illustrated in FIG. 6A. In an relation diagram 10a illustrated in FIG. 6A, the box 11b having an event name of “heater” and the box 11c having an event name of “power supply” are respectively connected to a box 11a having an event name of “hot-water is tepid” by the connectors 12a and 12b. In the present specification, the reference numerals of the boxes are used for identifying the boxes in the identical relation diagram. For this reason, the identical reference numeral may be used even in a case where event names are different from each other. The reference numerals of the connectors are also used for identifying the connectors in the identical relation diagram.

Further, the creator thinks out deterioration of a nichrome wire as a problem of the heater, thinks out voltage drop as a problem of the power supply, and modifies the tree as illustrated in FIG. 6B to complete the creation of an relation diagram 10b. In the relation diagram 10b illustrated in FIG. 6B, the box 11d having an event name of “deterioration of nichrome wire” and the box 11e having an event name of “voltage drop” are respectively connected to the box 11b of “heater” and the box 11c of “power supply” by the connectors 12c and 12d.

(1) Selection of Connector

Here, the creator operates the input unit 4 to move a cursor 5a to the connector 12a and select the connector 12a in the relation diagram 10b as illustrated in FIG. 6C. With reference to the relation diagram information 31, the conversion section 22 specifies the boxes 11a and 11b as a connection destination and a connection source of the connector 12a corresponding to a position of the cursor 5a in the relation diagram 10b, and obtains box IDs of the boxes 11a and 11b. The conversion section 22 obtains event names of “heater” and “hot-water is tepid”, and level numbers corresponding to the obtained box IDs from the attribute table 32.

In a case where the connector 12 is selected, the conversion section 22 highlights the selected connector 12a and the boxes 11a and 11b connected by the connector 12a in a different manner from the other connectors 12 and the other boxes 11. In a case illustrated in FIG. 6C, the lines are thicker than the drawn lines, and the lines having different colors are overlapped. The highlighting has the same manner as in the other relation diagrams 10.

The conversion section 22 refers to the conversion table 33 illustrated in FIG. 4 based on the obtained event name and level number, generates a sentence by inserting the event name “heater” having the larger level number into b and inserting the event name “hot-water is tepid” having the smaller level number into a in the sentence example 330a having a connector as a cursor position and one box as a connection source, pulls out a lead line 13 from the selected connector 12a as illustrated in FIG. 6C, and displays a sentence 14a of “heater is a direct cause of that hot-water is tepid” in a pop-up manner on the relation diagram 10b. In the sentence 14a, a portion surrounded by a broken line indicates a fixed portion of the sentence example 330a of the conversion table 33.

As illustrated in FIG. 6C, since the displayed sentence 14a is unnatural, the creator realizes that the sentence 14a is not established as a causal relationship.

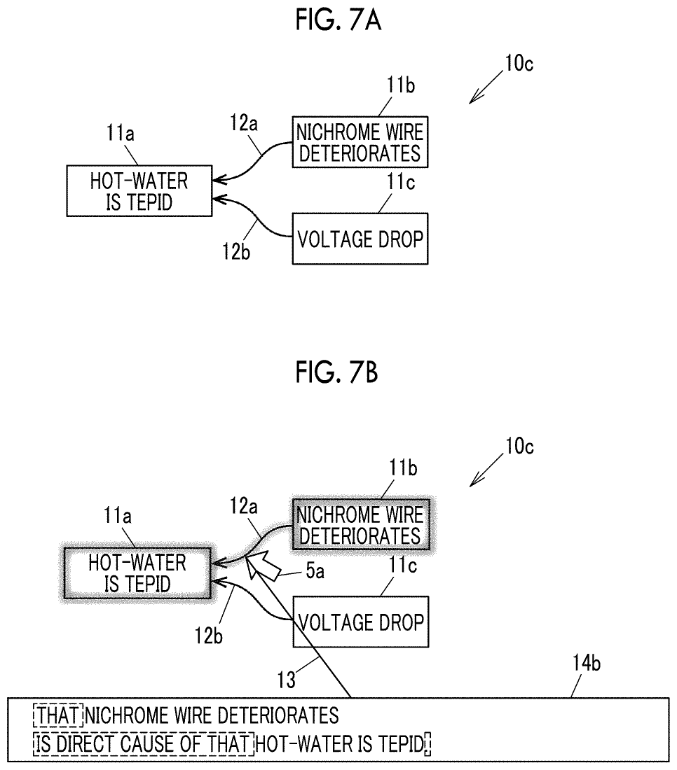

As illustrated in FIG. 7A, the creator deletes the boxes 11b and 11c at the second level illustrated in FIG. 6C, replaces the boxes 11b and 11c at the second level with the boxes 11d and 11e at the third level illustrated in FIG. 6C, and modifies the event name as necessary.

Here, the creator operates the input unit 4 to move the cursor 5a to the connector 12a and select the connector 12a in an relation diagram 10c as illustrated in FIG. 7B. With reference to the relation diagram information 31, the conversion section 22 obtains box IDs of the boxes 11a and 11b as a connection destination and a connection source connected by the connector 12a corresponding to a position of the cursor 5a in the relation diagram 10c. The conversion section 22 obtains event names of “nichrome wire deteriorates” and “hot-water is tepid”, and level numbers corresponding to the obtained box IDs from the attribute table 32.

The conversion section 22 refers to the conversion table 33 illustrated in FIG. 4 based on the obtained event name and level number, generates a sentence by inserting an event name of “nichrome wire deteriorates” into b and inserting an event name of “hot-water is tepid” into a in the sentence example 330a having a connector as a cursor position and one box as a connection source, pulls out the lead line 13 from the selected connector 12a as illustrated in FIG. 7B, and displays a sentence 14b of “that nichrome wire deteriorates is a direct cause of that hot-water is tepid” in a pop-up manner on the relation diagram 10c.

Since the displayed sentence 14b is natural as illustrated in FIG. 7B, the creator confirms that the causal relationship is established. On the other hand, there is a leap in the causal relationship, and it is noticed that the deterioration of the nichrome wire is not directly linked with a hot-water temperature as the causal relationship.

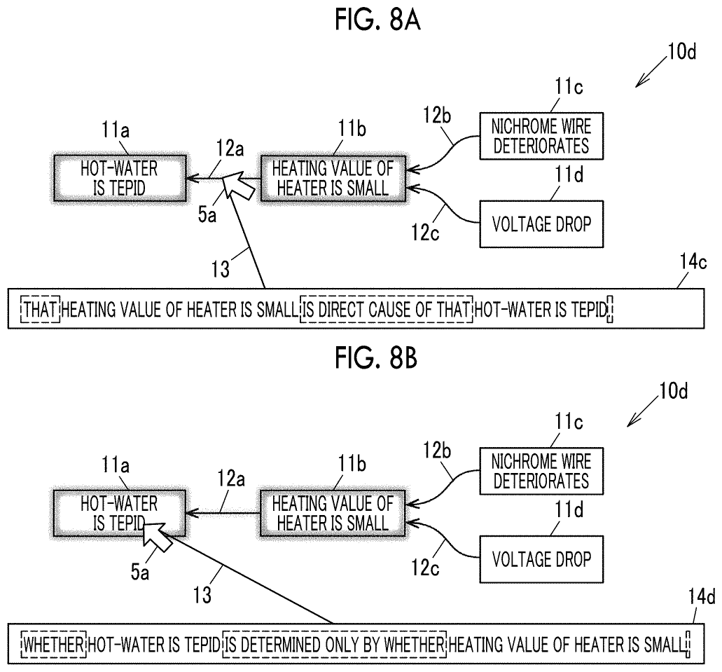

Therefore, as illustrated in FIG. 8A, the creator set the boxes 11b and 11c at the second level illustrated in FIG. 7B as the boxes 11c and 11d at the third level, and inserts the box 11b of “supplied heat is small” into the second level. In a case where the cursor 5a is moved to the connector 12a and the connector 12a is selected, a sentence is generated as described above, and a sentence 14c of “that supplied heat is small is a direct cause of that hot-water is tepid” is displayed on an relation diagram 10d in a pop-up manner. Thus, the creator confirms that the causal relationship is accurate.

(2) Selection of Box

As illustrated in FIG. 8B, in a case where the creator moves the cursor 5a to the box 11a and selects the box 11a, the conversion section 22 refers to the relation diagram information 31 and obtains box IDs of the box 11a corresponding to a position of the cursor 5a, and the box 11b connected to the box 11a by the connector 12a. The conversion section 22 obtains event names of “supplied heat is small” and “hot-water is tepid”, and the level numbers corresponding to the obtained box IDs from the attribute table 32.

In a case where the box 11 is selected, the conversion section 22 highlights the selected box 11a, the box 11b connected to the box 11a by the connector 12a, and the connector 12a in a different manner from the other boxes 11 and the other connectors 12. In a case illustrated in FIG. 8B, the lines are thicker than the drawn lines, and the lines having different colors are overlapped. The highlighting has the same manner as in the other relation diagrams 10.

The conversion section 22 refers to the conversion table 33 illustrated in FIG. 4 based on the obtained event name and level number, generates a sentence by inserting an event name of “hot-water is tepid” into a and inserting an event name of “supplied heat is small” into b in the sentence example 330b having a box as a cursor position and one box as a connection source, and displays a sentence 14d of “whether hot-water is tepid is determined only by whether supplied heat is small” in a pop-up manner on the relation diagram 10d as illustrated in FIG. 8B.

Here, after thinking again, the creator realizes that there are other factors which determine the hot-water temperature. That is, in order to be able to say that it is determined only by “AA” and “BB”, it is necessary to consider appropriate factors. As a result, the creator realizes that the hot-water temperature is determined by a heating value to be added and a heat capacity of an object to be heated.

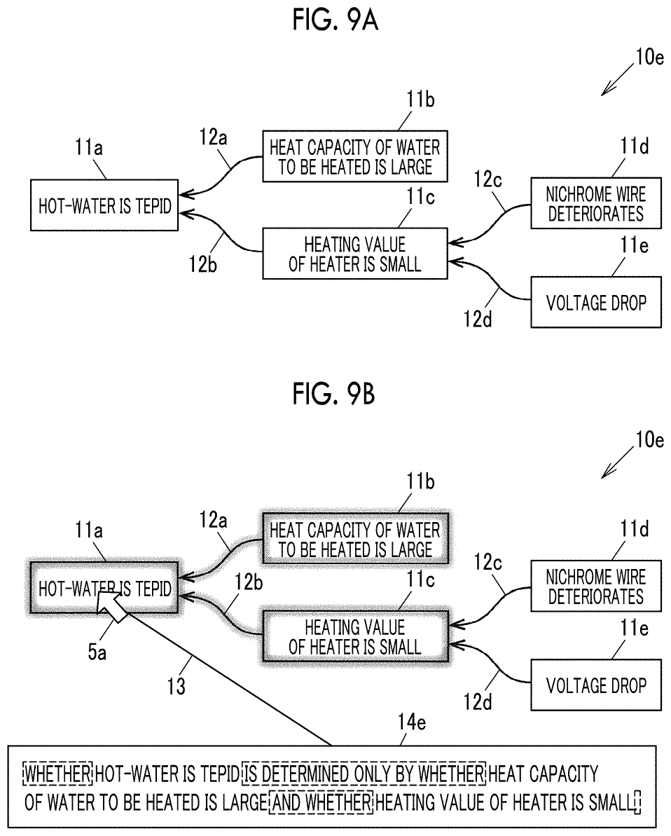

As illustrated in FIG. 9A, the creator adds the box 11b of “heat capacity of water to be heated is large” as a factor of “hot-water is tepid”. As illustrated in FIG. 9B, in a case of moving the cursor 5a to the box 11a of “hot-water is tepid” and selecting the box 11a, the conversion section 22 refers to the relation diagram information 31 and obtains box IDs of the box 11a corresponding to a position of the cursor 5a, and the boxes 11b and 11c connected to the box 11a by the connector 12a. The conversion section 22 obtains event names of “hot-water is tepid”, “heat capacity of water to be heated is large”, and “supplied heat is small”, and the level numbers corresponding to the obtained box IDs from the attribute table 32.

The conversion section 22 refers to the conversion table 33 illustrated in FIG. 4 based on the obtained event name and level number, generates a sentence by inserting “hot-water is tepid” into a, inserting “supplied heat is small” into b, and inserting “heat capacity of water to be heated is large” in c in the sentence example 330c having a box as a cursor position and two boxes as connection sources, and displays a sentence 14e of “whether hot-water is tepid is determined only by whether heat capacity of water to be heated is large and whether heating value of heater is small” in a pop-up manner on an relation diagram 10e as illustrated in FIG. 9B. The creator checks the graphic expression of a causal relationship in sentences and confirms that there is no omission in the factors.

Modification 1

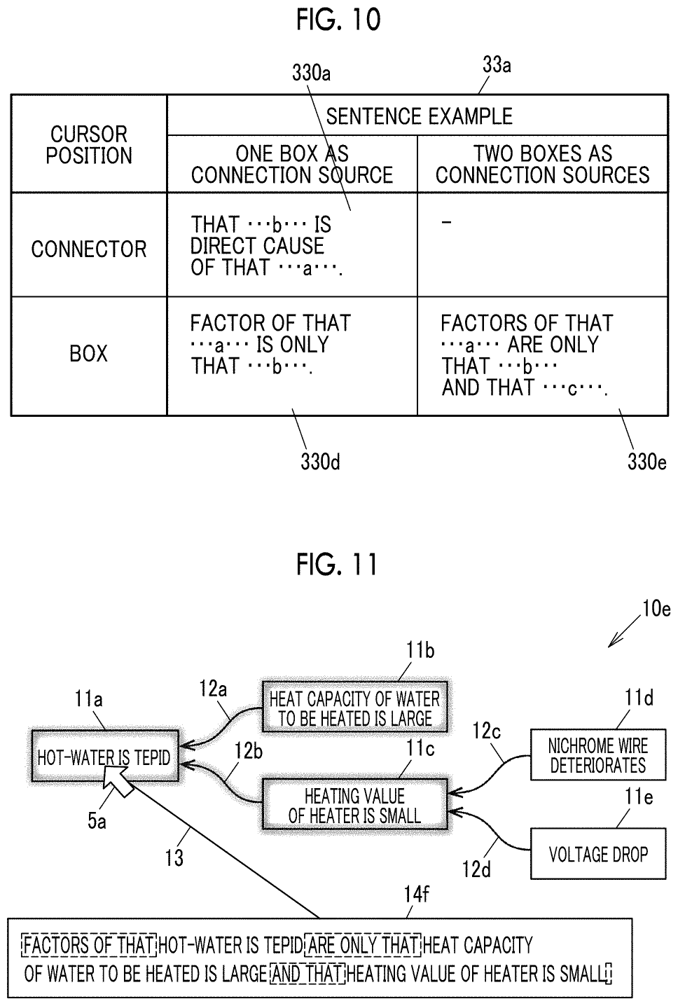

FIG. 10 is a diagram illustrating an example of a conversion table according to Modification 1. A conversion table 33a illustrated in FIG. 10 is different from the conversion table 33 illustrated in FIG. 4 in that the sentence example in a case where the cursor position is a box is changed.

As illustrated in FIG. 11, in a case of moving the cursor 5a to the box 11a and selecting the box 11a, based on a sentence example 330e of the conversion table 33a as described above, a sentence 14f of “factors of that hot-water is tepid are only that heat capacity of water to be heated is large and that supplied heat is small” is generated and is displayed in a pop-up manner on the relation diagram 10e.

Modification 2

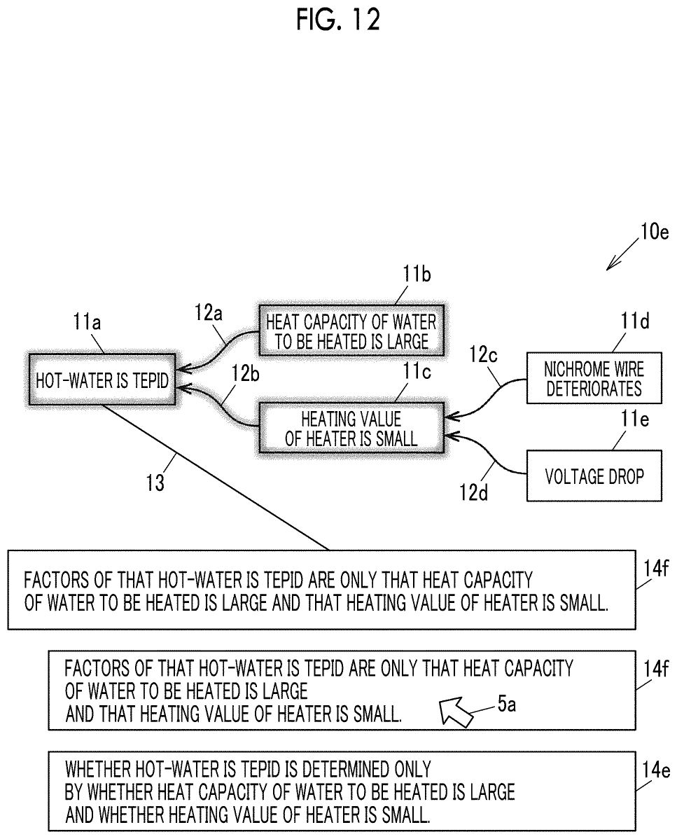

In Modification 2, a plurality of types of sentences are displayed, and one of the sentences can be selected. FIG. 12 illustrates a state in which the sentence 14e illustrated in FIG. 9B and the sentence 14f illustrated in FIG. 11 are displayed in a pop-up manner, and the cursor 5a is moved to the sentence 14f illustrated in FIG. 11 and the sentence 14f is selected. The selected sentence 14f is connected to the box 11a by the lead line 13.

### Second Exemplary Embodiment

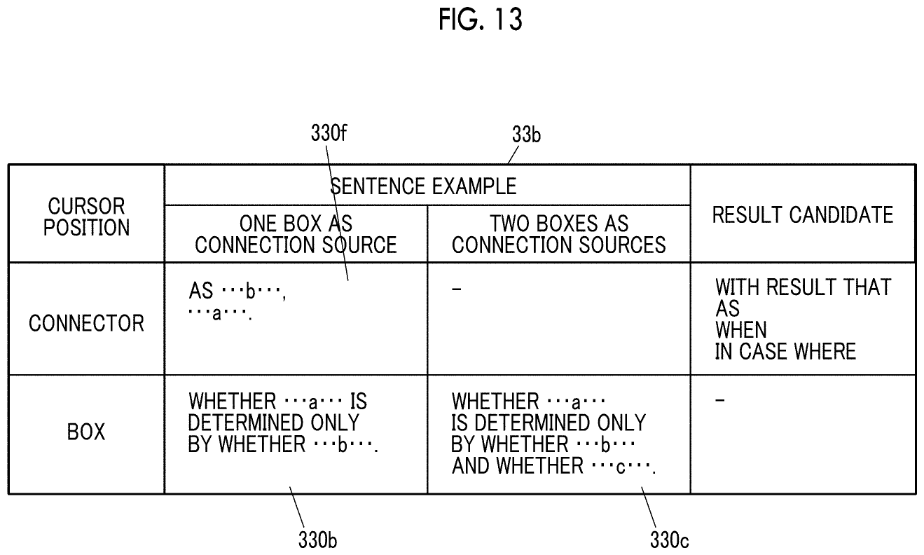

FIG. 13 is a diagram illustrating an example of a conversion table according to a second exemplary embodiment of the invention. The conversion table 33b according to the present exemplary embodiment has items such as “cursor position”, “sentence example”, and “result candidate”. The “cursor position” includes a connector and a box, and the “sentence example” includes a case where the number of boxes as connection sources is one and a case where the number of boxes as connection sources is two. The event names described with reference to FIG. 4 are inserted into a and b of the sentence example 330b and a, b, and c of the sentence example 330c having a box as a cursor position. The sentence example 330f having a connector as a cursor position is different from the sentence example 330a in FIG. 4, and uses the expression of “as”. In the “result candidate”, “with result that”, “as”, “when”, and “in case where” are recorded.

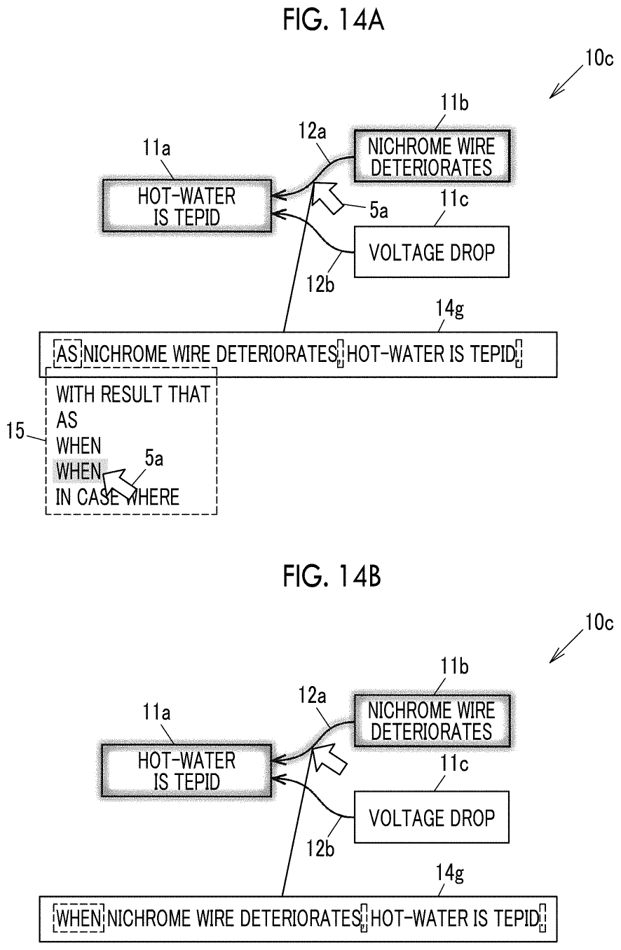

FIGS. 14A and 14B are diagrams illustrating an example of an relation diagram according to the second exemplary embodiment. In the relation diagram 10c illustrated in FIG. 14A, when the connector 12a is selected, a sentence 14g is generated with reference to the sentence example 330f of the conversion table 33b in FIG. 13, and a state in which result candidates are displayed by a pull-down menu 15 and “when” is selected as a result candidate is illustrated. In a case where the “when” is selected, the sentence 14g illustrated in FIG. 14B is obtained by replacing with “when”. Appropriate sentences may be displayed by utilizing a dictionary or machine learning corresponding to an event and a logical relationship.

### Third Exemplary Embodiment

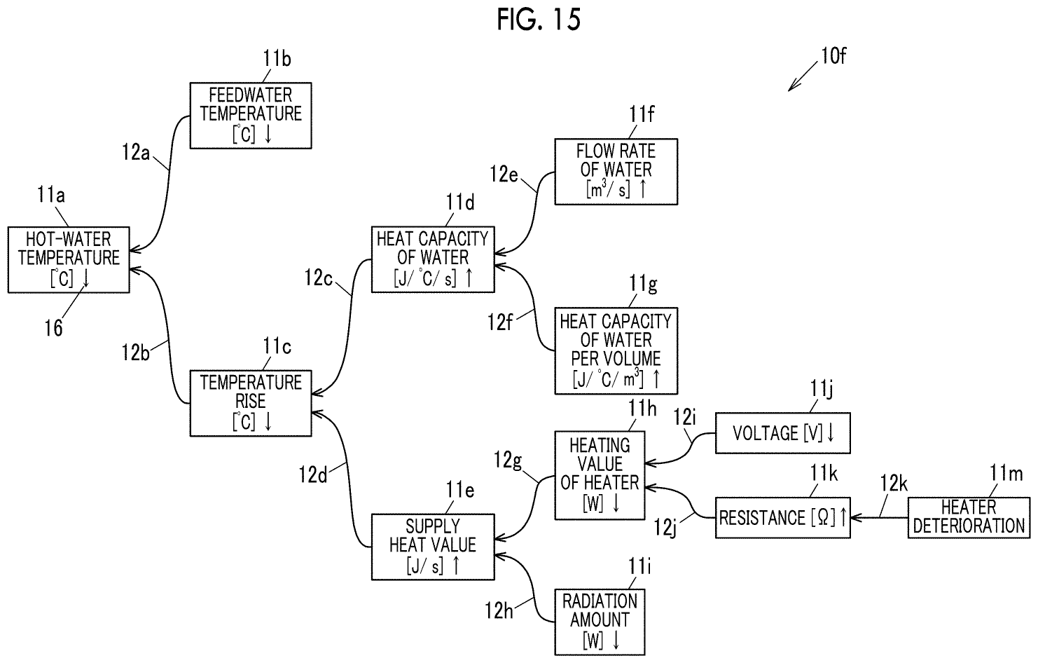

FIG. 15 is a diagram illustrating an example of an relation diagram according to a third exemplary embodiment of the invention. In the present exemplary embodiment, an arrow indicating a large or small is added to an event name. There may be a box to which the arrow indicating the large or small is not added. In an relation diagram 10f illustrated in FIG. 15, the boxes 11b and 11c at a second level are connected to the boxes 11a at a first level via the connectors 12a and 12b, the boxes 11d and 11e at a third level are connected to the boxes 11c at the second level via the connectors 12c and 12d, boxes 11f and 11g at a fourth level are connected to the box 11d at the third level via connectors 12e and 12f, boxes 11h and 11i at the fourth level are connected to the box 11e at the third level via connectors 12g and 12h, boxes 11j and 11k at a fifth level are connected to the box 11h at the fourth level via the connectors 12i and 12j, and a box 11m is connected to the box 11k at the fifth level via a connector 12k.

The arrow added to each box 11 indicates that a value to quantify an event described in the box 11 is increased or decreased. An upward arrow indicates an increase and a downward arrow indicates a decrease. A case where the upward arrow is added to each of the parent event and the child event indicates that a value of the parent event also increases as a value of the child event increases.

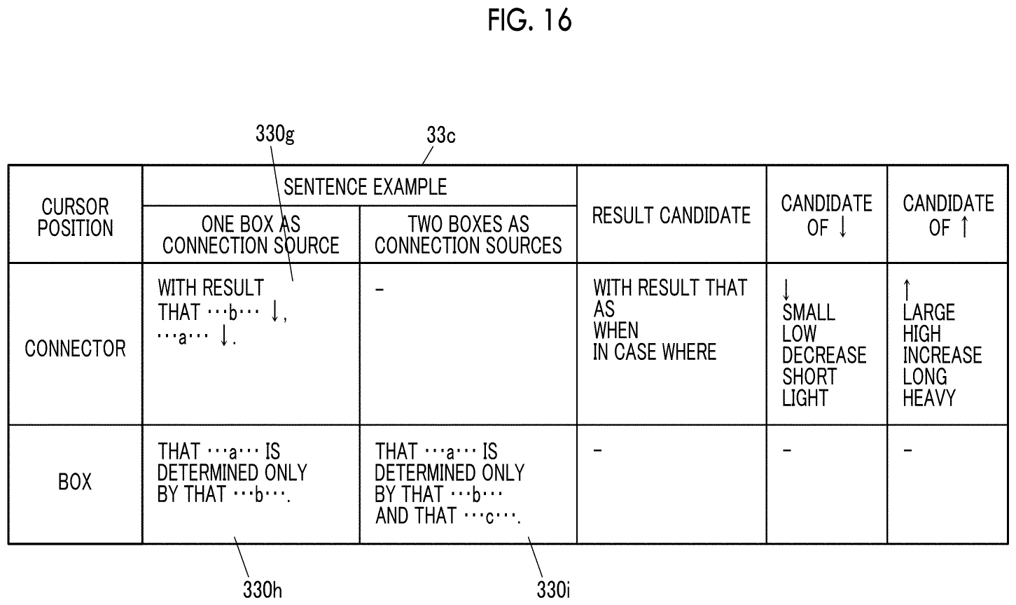

FIG. 16 is a diagram illustrating an example of a conversion table according to the third exemplary embodiment. A conversion table 33c illustrated in FIG. 16 is obtained by transforming the sentence examples 330b, 330c, and 330f illustrated in FIG. 13 into sentence examples 330g, 330h, and 330i, and by adding items of “candidate of ↓” and “candidate of ↑” to the conversion table 33b illustrated in FIG. 13. In the “candidate of ↓”, “↓”, “small”, “low”, “decrease”, “short”, “light” are recorded, and in the “candidate of ↑”, “↑”, “large”, “high”, “increase”, “long”, and “heavy” are recorded. The “candidate of ↓” and the “candidate of ↑” are examples of candidates having meaning of the arrow.

The conversion section 22 according to the present exemplary embodiment displays candidates having the meaning of the arrow in a selectable manner in addition to the above-described functions. The meaning of the arrow includes a state and a change. For example, “small”, “low”, “short”, and “light” of the “candidate of ↓” illustrated in FIG. 16 indicate the state, and “decrease” indicates the change. In addition, “large”, “high”, “long”, and “heavy” of the “candidate of ↑” indicate the state, and “increase” indicate the change.

The conversion section 22 may display the arrow in a selectable manner depending on whether the meaning of the arrow is the state or the change. In this case, in a case where the candidates are displayed in a pop-up manner, the candidates indicating the state and the candidates indicating the change may be displayed in different colors to be easily selected. Further, the meaning of the arrow may be displayed in a natural language using a dictionary corresponding to an event and a logical relationship.

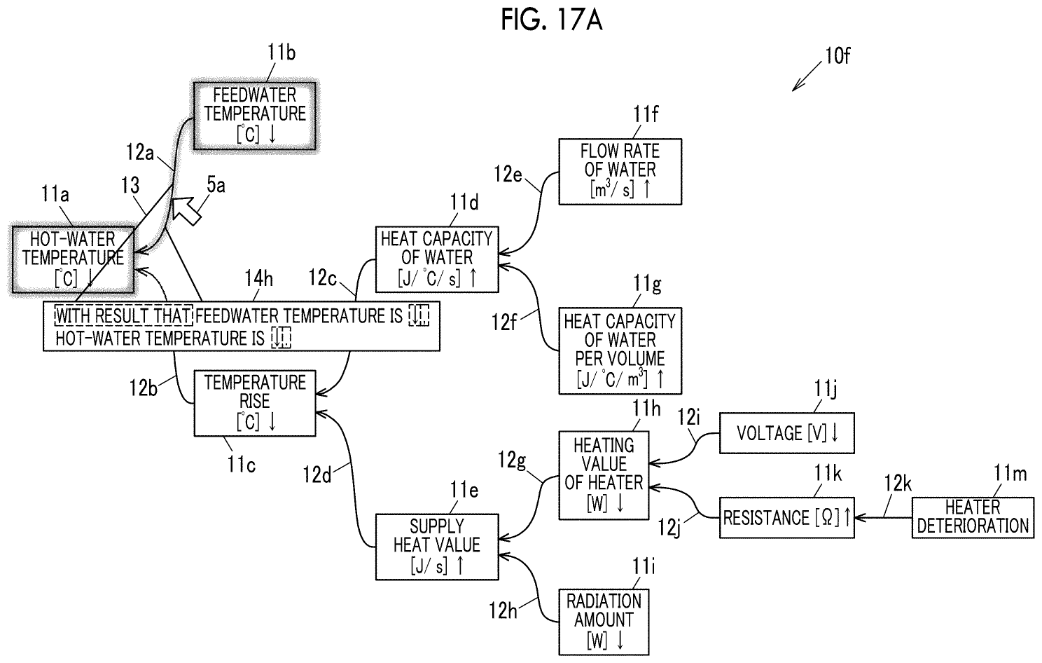

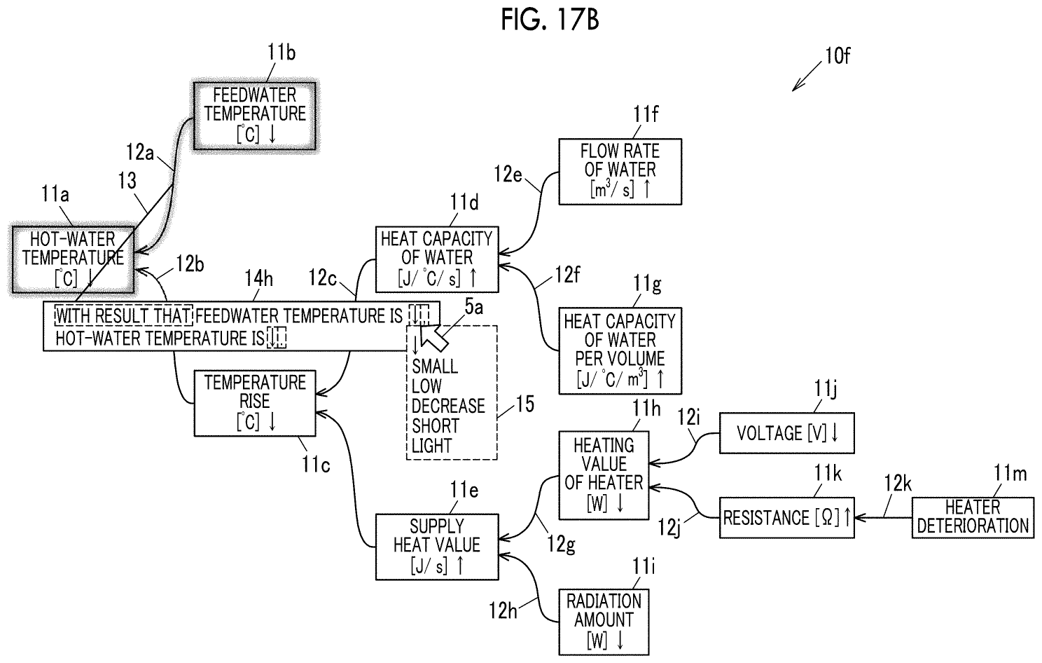

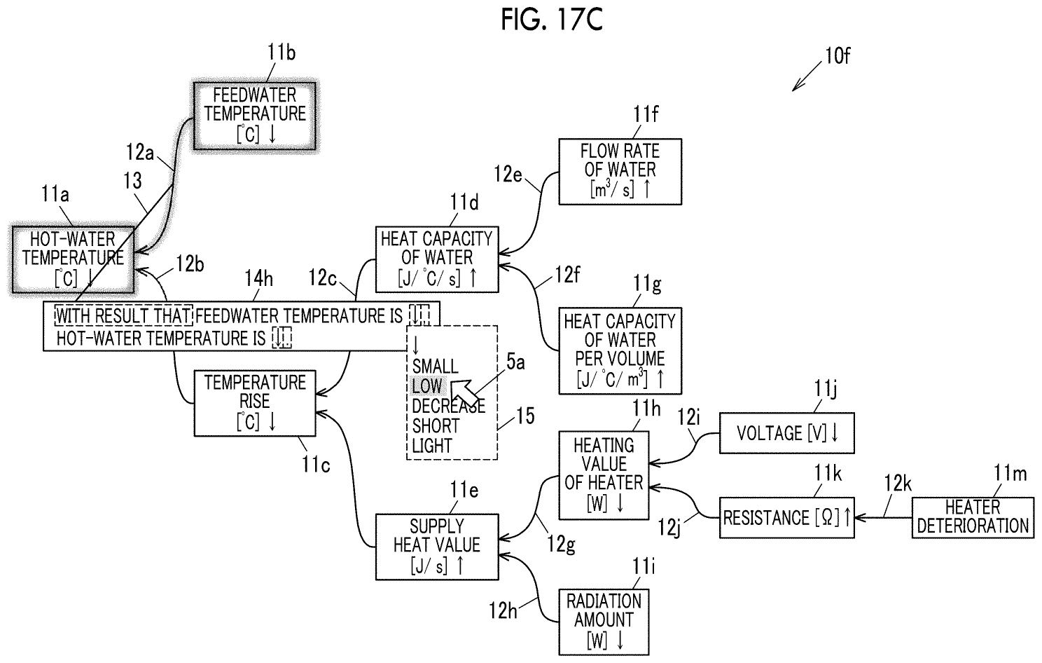

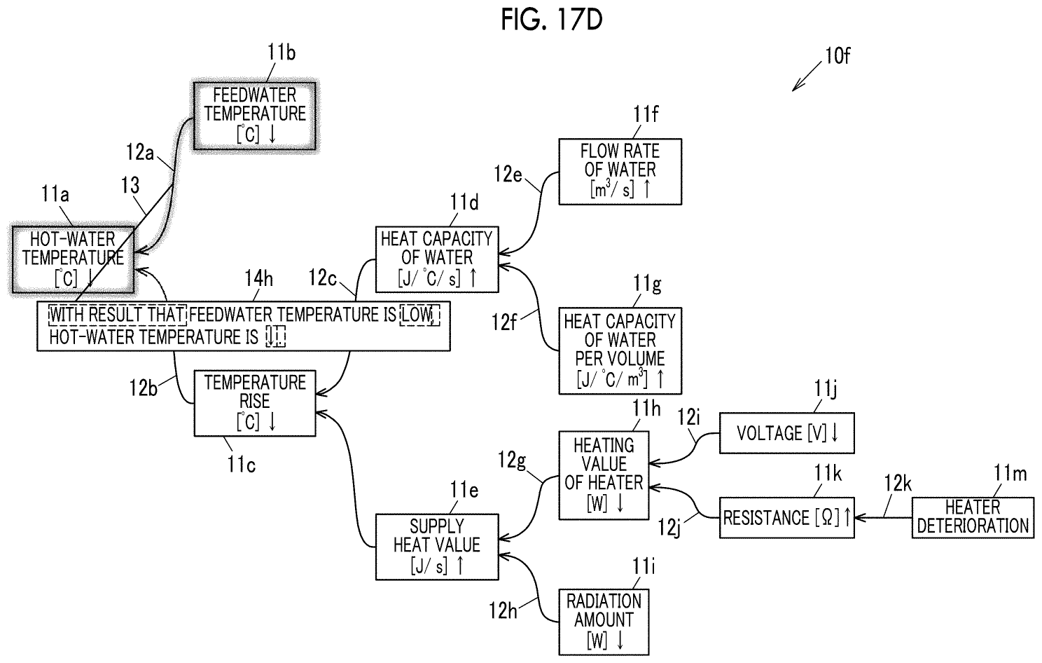

As illustrated in FIG. 17A, in a case where the cursor 5a is moved to the connector 12a and the connector 12a is selected, an event name is applied to the sentence example 330g of the conversion table 33c illustrated in FIG. 16 as described above, and a sentence 14h of “with result that feedwater temperature is ↓, hot-water temperature is ↓.” is generated and is displayed in a pop-up manner on the relation diagram 10f.

As illustrated in FIG. 17B, in a case where the cursor 5a is moved to the first candidate text of the sentence 14h (the text surrounded by the broken line in FIG. 17B), the pull-down menu 15 appears, and in a case where “low” is selected by the cursor 5a as illustrated in FIG. 17C, the sentence 14h is converted into the sentence 14h including the selected “low” as illustrated in FIG. 17D.

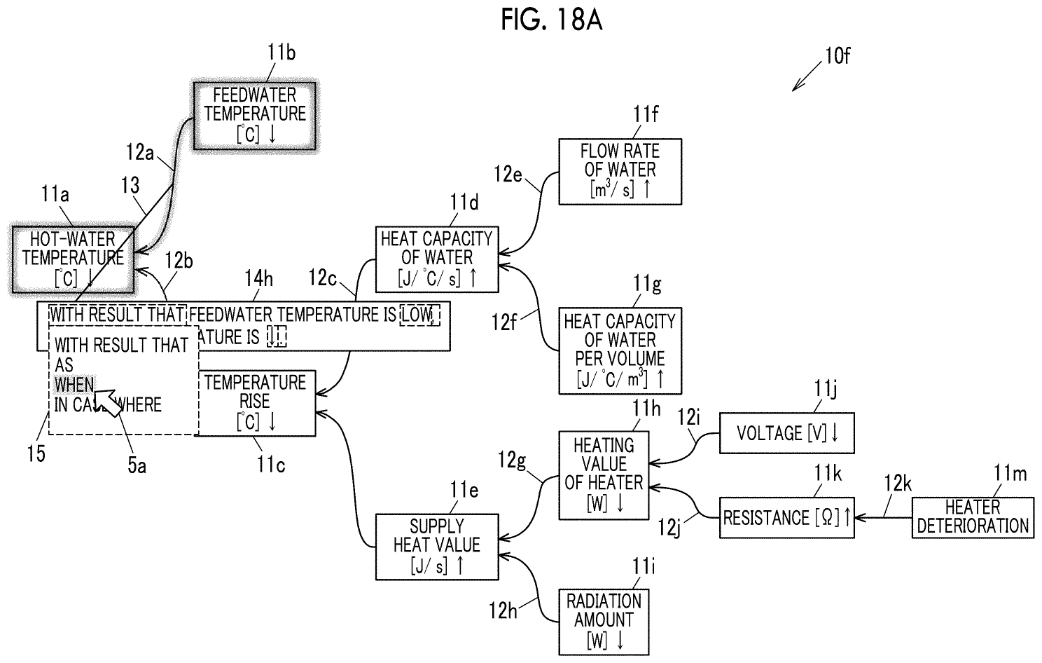

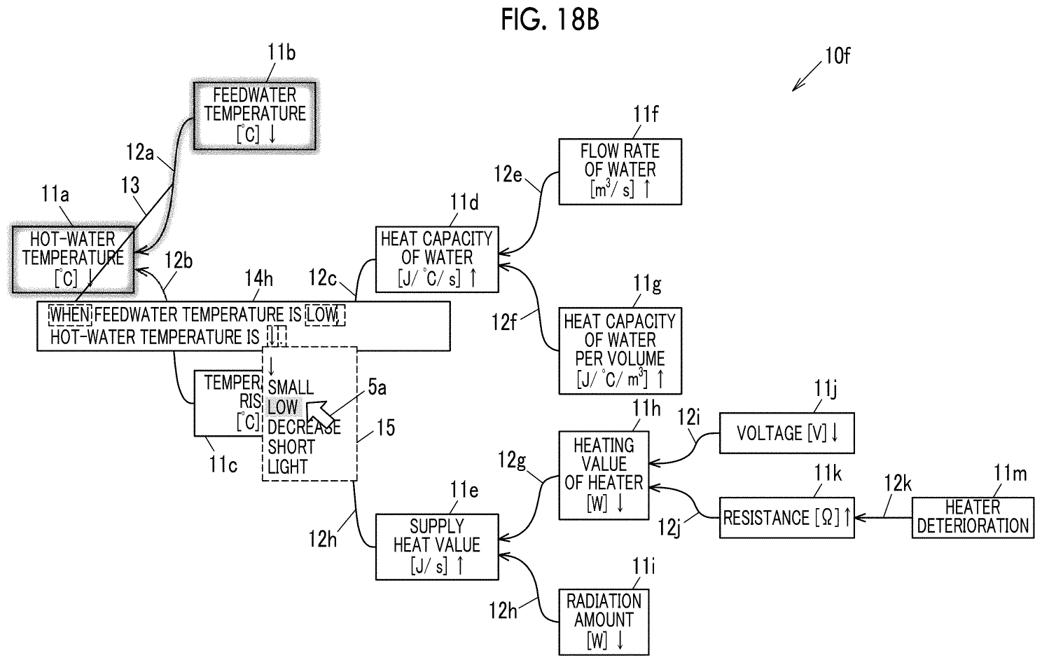

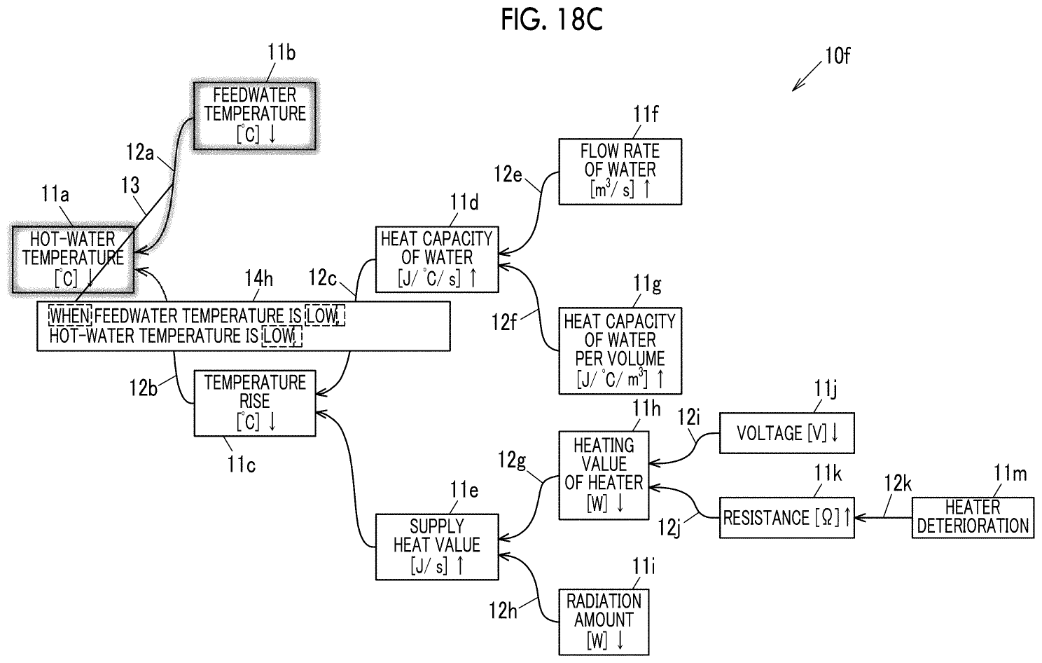

In a case where the cursor 5a is moved to the next candidate text, a candidate text of “with result that” is displayed on the pull-down menu 15 as illustrated in FIG. 18A, and in a case where the cursor 5a is moved to “when” and “when” is selected, the sentence 14h in which “with result that” is converted into “when” is obtained as illustrated in FIG. 18B. In a case where the cursor 5a is moved to the last candidate text and “low” is selected from the pull-down menu 15, the sentence 14h is determined as illustrated in FIG. 18C.

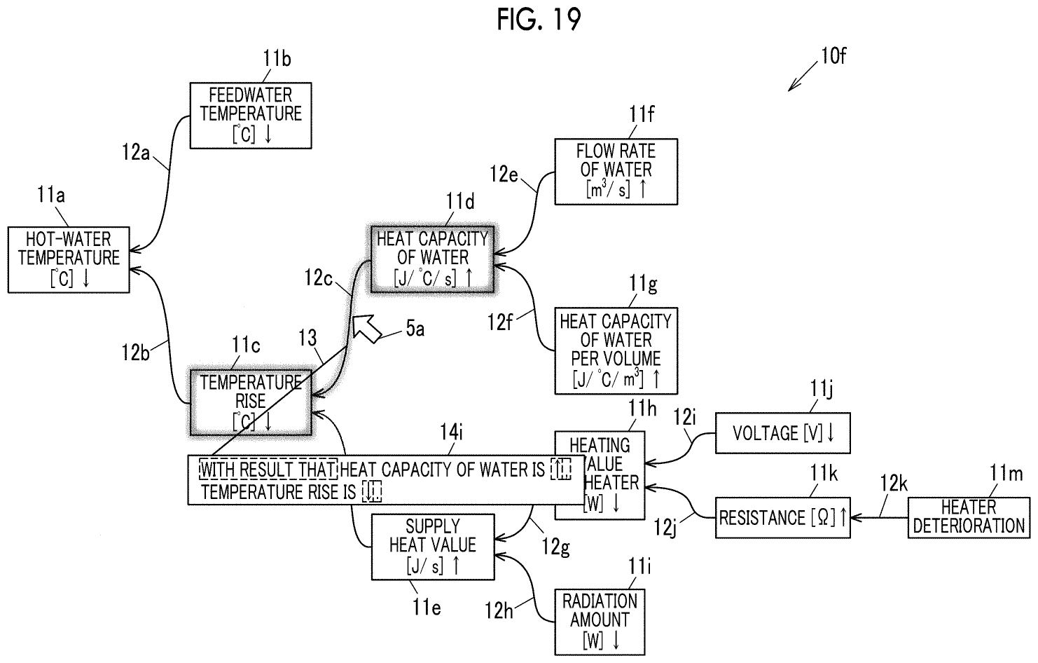

As illustrated in FIG. 19, in a case where the cursor 5a is moved to the connector 12c and the connector 12c is selected, an event name is applied to the sentence example 330g of the conversion table 33c illustrated in FIG. 16 as described above, and a sentence 14i of “with result that heat capacity of water is ↑, temperature rise is ↓.” is displayed in a pop-up manner on the relation diagram 10f.

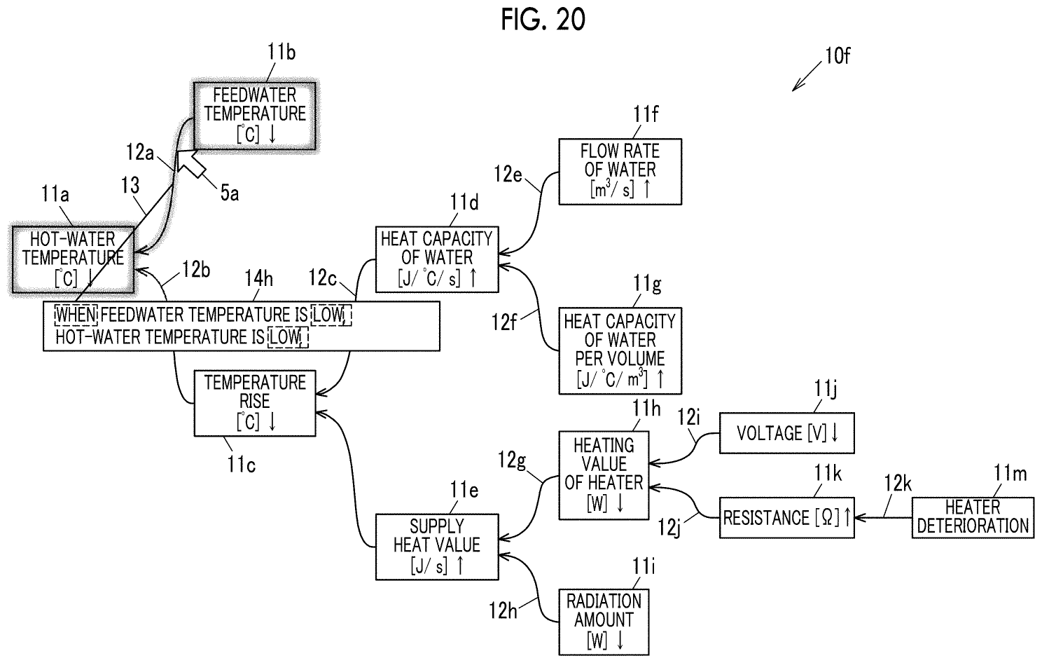

As illustrated in FIG. 20, in a case where the cursor 5a is moved to the connector 12a and the connector 12a is selected, the sentence 14h of “when feedwater temperature is low, hot-water temperature is low.” edited in FIG. 18C is displayed in a pop-up manner on the relation diagram 10f.

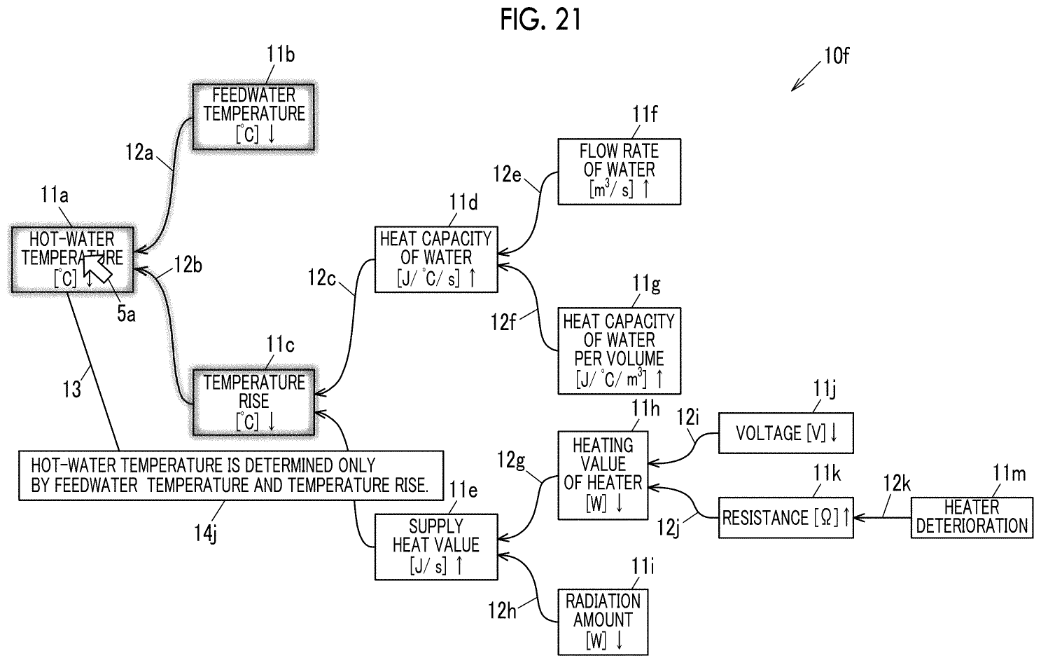

Next, as illustrated in FIG. 21, in a case where the cursor 5a is moved to the box 11a and the box 11a is selected, an event name is applied to a sentence example 330i of the conversion table 33c illustrated in FIG. 16 as described above, and a sentence 14j of “hot-water temperature is determined only by feedwater temperature and temperature rise” is displayed in a pop-up manner on the relation diagram 10f.

In the sentence example 330i of the conversion table 33c illustrated in FIG. 16, “as b and c are determined, a is determined” may be used as “a is determined only by b and c”. In a case in FIG. 21, “as feedwater temperature and temperature rise are determined, hot-water temperature is determined” is obtained.

Although the exemplary embodiments of the invention are described above, the exemplary embodiment of the invention are not limited to the above embodiments, and various modifications and implementations are possible without departing from the gist of the exemplary embodiment of the invention. For example, in each of the above exemplary embodiments, the logical relationship indicated by the relation diagram is converted into the sentence and displayed on the display unit 5, but the logical relationship may be converted into the sentence, and the sentence may be further converted into a voice and the voice may be output.

In each of the above exemplary embodiments, the causal relationship is described as a logical relationship, but the exemplary embodiment of the invention may be applied to another relationship such as an equal relationship or an opposition relationship. In each of the above embodiments, the causal relationship between a cause or a factor and a result is described as a logical relationship, but the exemplary embodiment of the invention may be applied to other causal relationships such as a reason and an assertion.

Each section of the control unit 2 may be configured by a hardware circuit such as a field programmable gate array (FPGA) of which a part or whole is reconfigurable or an application specific integrated circuit (ASIC).

Further, some components of the above-described exemplary embodiment can be omitted or changed without departing from the scope of the exemplary embodiment of the invention. In addition, steps can be added, deleted, changed, replaced, and the like in the flow of the above-described exemplary embodiment without departing from the scope of the exemplary embodiment of the invention. Further, the program used in the above exemplary embodiment can be provided by being recorded on a computer-readable recording medium such as a CD-ROM, and can be used via a network by being stored in an external server such as a cloud server.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a conversion section that converts, on an relation diagram expressing a logical relationship between a plurality of events, the logical relationship of a designated location into a natural language and outputs the natural language.

2. The information processing apparatus according to claim 1,
wherein the relation diagram includes an event component indicating the event, and a connection component that connects the events, and
the conversion section outputs the natural language in accordance with whether the designated location is the event component or the connection component.

3. The information processing apparatus according to claim 2,
wherein in a case where the designated location is the event component, the conversion section outputs the natural language for checking whether or not an event directly connected as a factor of a target event is appropriate as the factor.

4. The information processing apparatus according to claim 3,
wherein the natural language is to check that there is no other event other than the event directly connected as the factor of the target event.

5. The information processing apparatus according to claim 2,
wherein in a case where the designated location is the connection component, the conversion section outputs the natural language of checking whether or not an event connected as a factor of a target event is appropriate as the factor.

6. The information processing apparatus according to claim 5,
wherein the natural language is to check that the event connected as the factor of the target event is a direct factor.

7. The information processing apparatus according to claim 2,
wherein the event component includes an arrow indicating an increase or a decrease of a value to quantify the event, and
in a case where the event component is designated, the conversion section outputs the natural language of an expression having meaning of the arrow of appropriate to the event or the logical relationship.

8. The information processing apparatus according to claim 3,
wherein the event component includes an arrow indicating an increase or a decrease of a value to quantify the event, and
in a case where the event component is designated, the conversion section outputs the natural language of an expression having meaning of the arrow of appropriate to the event or the logical relationship.

9. The information processing apparatus according to claim 4,
wherein the event component includes an arrow indicating an increase or a decrease of a value to quantify the event, and
in a case where the event component is designated, the conversion section outputs the natural language of an expression having meaning of the arrow of appropriate to the event or the logical relationship.

10. The information processing apparatus according to claim 5,
wherein the event component includes an arrow indicating an increase or a decrease of a value to quantify the event, and
in a case where the event component is designated, the conversion section outputs the natural language of an expression having meaning of the arrow of appropriate to the event or the logical relationship.

11. The information processing apparatus according to claim 6,
wherein the event component includes an arrow indicating an increase or a decrease of a value to quantify the event, and
in a case where the event component is designated, the conversion section outputs the natural language of an expression having meaning of the arrow of appropriate to the event or the logical relationship.

12. The information processing apparatus according to claim 7,
wherein the conversion section selectively displays a candidate of the meaning of the arrow.

13. The information processing apparatus according to claim 8,
wherein the conversion section selectively displays a candidate of the meaning of the arrow.

14. The information processing apparatus according to claim 9,
wherein the conversion section selectively displays a candidate of the meaning of the arrow.

15. The information processing apparatus according to claim 10,
wherein the conversion section selectively displays a candidate of the meaning of the arrow.

16. The information processing apparatus according to claim 11,
wherein the conversion section selectively displays a candidate of the meaning of the arrow.

17. The information processing apparatus according to claim 12,
wherein the conversion section selectively displays the candidate of the meaning of the arrow in accordance with whether the meaning of the arrow is a state or a change.

18. The information processing apparatus according to claim 7,
wherein the meaning of the arrow is displayed in the natural language using a dictionary corresponding to the event and the logical relationship.

19. The information processing apparatus according to claim 1,
wherein the conversion section selectively displays a plurality of candidates as the natural language.

20. A non-transitory computer readable medium storing a program causing a computer to function as:
a conversion section that converts, on an relation diagram expressing a logical relationship between a plurality of events, the logical relationship of a designated location into a natural language and outputs the natural language.
